(19) United States
(12) Patent Application Publication
(10) Pub. No.: US 2005/0122547 A1
(43) Pub. Date: Jun. 9, 2005

(54) Image reader and image forming apparatus

(75) Inventor: Hisashi Yamanaka, Yamatokoriyama-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/002,336

(22) Filed: Nov. 30, 2004

(30) Foreign Application Priority Data
Dec. 5, 2003 (JP) P2003-407450

(51) Int. Cl. H04N 1/04

(52) U.S. Cl. 358/474

(57) ABSTRACT

A light source unit rests at a standby position at which the light source unit faces a lower side of a first platen and fails to face a portion adjacent an end of the first platen during standby for reading and in the off-state of an image reader. Powdery paper and the like falling from the end portion of the first platen fail to adhere to the light source unit.

### CROSS REFERENCE

This Nonprovisional application claims priority under 35 U.S.C. § 119(a) on Patent Application No. 2003-407450 filed in Japan on Dec. 5, 2003, the entire contents of which are hereby incorporated by reference.

### BACKGROUND OF THE INVENTION

The present invention relates to an image reader for reading the image of a document on a platen and an image forming apparatus incorporating the same.

There are various document read systems applicable to image readers to be fitted on image forming apparatus, including: a system adapted to scan a sheet- or book-shaped document stationarily set on the platen (platen glass) by an optical reader; a system adapted to scan a sheet-shaped document automatically fed onto the platen and rendered stationary thereon by an optical reader as disclosed in Japanese Patent Application Laid-Open Nos. S62-49342 and 2001-24856; and a system adapted to read a sheet-shaped document being fed over the platen by an optical reader rendered stationary below the platen.

One conventional image reader is capable of selecting one of the two systems of the aforementioned read systems, i.e., the stationary document read system for image reading by causing the optical reader to scan a stationary document and the feed-and-read system for reading a document being fed by the stationary optical reader.

Particularly, an image reader which is designed to use a single optical reader in both of the stationary document read system and the feed-and-read system is configured to perform document image reading in a stationary document read mode based on the stationary document read system with the optical reader located differently from the case of a feed-and-read mode based on the feed-and-read system. For this reason, the optical reader is controlled to move from a predetermined standby position to a reading start position established for a selected read mode prior to the starting of document image reading. Further, the standby position of the optical reader is established as the reading start position in one of the stationary document read mode and the feed-and-read mode, whereby the operation of moving the optical reader prior to the starting of document image reading can be eliminated as the case may be.

In an image reader, usually, the optical reader rests at the standby position at which the optical reader is ready to read a document image immediately upon the starting of image reading. Generally, the home position, which is the standby position of the optical reader, is established at a location opposite to an end portion of the platen. In the aforementioned image reader using the single optical reader in both of the stationary document read mode and the feed-and-read mode, one of the stationary document read mode and the feed-and-read mode has priority over the other and the reading start position in the priority mode is established at the same location as the standby position of the optical reader in that mode, whereby the operation of moving the optical reader to the reading start position can be eliminated when the priority mode is selected. Usually, the reading start position is established at the same location as the standby position of the optical reader in the feed-and-read mode.

In many cases such an image reader of the type using a single optical reader in both of the modes is provided with separate platens to be used in respective of the stationary document read mode and the feed-and-read mode. The platen to be used in the feed-and-read mode has a narrow width in the document feed direction since the optical reader remains stationary during reading. Accordingly, the standby position of the optical reader is close to an end portion of that platen, whichever mode is selected as the priority mode.

The end portion of such a platen is fitted with a fixing member fixing the platen on top of the apparatus and a reference member bearing a reference mark indicating a document setting position, which are secured by means of a fastening member (screw) and the like. For this reason, a clearance is likely defined between the platen and the fixing member, the reference member or the like.

The fixing member, reference member and the like are removably mounted on support members such as the apparatus frame, cabinet cover and the like so that the platen can be removed for its cleaning and for maintenance of the optical reader.

A screw having tapping capability is used as the fastening member for reducing the manufacturing cost. As the screw is screwed into a hole formed in such a support member, the screw fastens the fixing member, reference member or the like to the support member while tapping the bore of the hole. For this reason, it is possible that cuttings or swarf produced from the support member by tapping remains at the end portion of the platen. In addition, powdery paper and dust produced during feeding of documents are likely to collect in the clearance defined between the platen and the fixing member, reference member or the like adjacent the end portion of the platen.

Such cuttings, powdery paper and dust (hereinafter referred to as “powdery paper and the like” as the case may be) collecting in the clearance defined between the platen and the fixing member, reference member or the like adjacent the end portion of the platen fall by propagation of vibration generated during the operation of the image forming apparatus or due to removal of the platen for maintenance. This results in a problem that the optical reader resting at the standby position below the end portion of the platen is soiled or damaged by such powdery paper and the like. Particularly where deflection means (mirror), which forms part of the optical reader, for guiding reflected light from the document to photoelectric conversion means is soiled or damaged, a reading failure (missing of information) occurs due to blocking off of the reflected light from the document, thus resulting in a substantial degradation in reading quality. Further, image formation based on data read with a degraded reading quality incurs a substantial degradation in image quality.

A feature of the present invention is to provide image reader and image forming apparatus which are capable of keeping satisfactory image reading and formation by avoiding powdery paper and the like from falling on the optical reader due to propagation of vibration from the image forming apparatus or the operation of removing the platen for maintenance, by establishing the standby position of the optical reader at a location sufficiently spaced apart from an end portion of the platen thereby preventing the optical reader from being soiled or damaged by such powdery paper and the like.

### SUMMARY OF THE INVENTION

According to the present invention, a standby position at which an optical reader rests during standby for image read processing is established at a location where the optical reader fails to face an end portion of the platen which lies in a direction in which the optical reader moves relative to the image bearing side of the document.

The foregoing and other features and attendant advantages of the present invention will become more apparent from the reading of the following detailed description of the invention in conjunction with the accompanying drawings.

### BRIEF DESCRIPTION OF THE DRAWINGS

FIG. 1 is a view illustrating an example of the construction of a digital multifunction machine as an image forming apparatus according to an embodiment of the present invention;

FIG. 2 is a sectional view of an image reader forming the image reading section of the digital multifunction machine according to the embodiment;

FIG. 3 is a block diagram showing the electrical configuration of the image reader shown in FIG. 2;

FIG. 4 is a plan view showing an operating section of the image reader;

FIG. 5 is a flowchart of a processing procedure followed by a control section of the image reader;

FIG. 6A is a view illustrating a portion of the image reader around first and second platens for locating a reading start position of a light source unit;

FIG. 6B is a view locating a standby position of the light source unit;

FIG. 7 is a view illustrating the light source unit and a mirror unit of the image reader in their fixed conditions; and

FIG. 8 illustrates a bundle of reflected light rays extending from an image bearing side of a document to a CCD in the image reader.

### DETAILED DESCRIPTION OF THE INVENTION

The present invention will now be described with reference to the accompanying drawings.

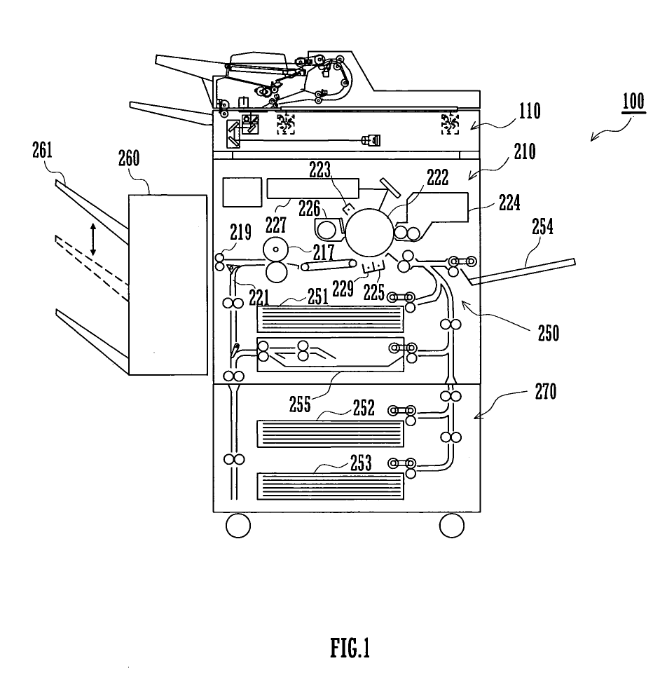

FIG. 1 is a view illustrating an example of the construction of a digital multifunction machine as an image forming apparatus according to an embodiment of the present invention. The digital multifunction machine 100 includes an image reading section 110 comprising an image reader according to the present invention, an image forming section 210, and a paper feed section 250 and is provided with a post-processing device 260 and a multi-tier paper feeder unit 270. The details of the image reading section 110 will be described later.

A document image read by the image reading section 110 is transferred to the image forming section 210. The document image thus read is inputted as image data to a non-illustrated image data input section in the image forming section 210. The image data thus inputted is subjected to predetermined image processing and then temporarily stored in memory incorporated in an image processing section. In response to an instruction to output the stored image data, the image data is read out of the memory and transferred to a laser writing unit 227 as an optical writing device included in the image forming section 210.

The image forming section 210 includes a rotatably supported photosensitive drum 222, and, around the photosensitive drum 222, an electrostatic charger 223 for charging the surface of the photosensitive drum 222 to a predetermined potential, laser writing unit 227 for forming an electrostatic latent image on the surface of the photosensitive drum 222 by irradiating the surface of the photosensitive drum 222 with laser light modulated according to the image data, a developing device 224 for supplying toner onto the electrostatic latent image formed on the photosensitive drum 222 to make the image tangible, a transfer device 225 for transferring the toner image formed on the surface of the photosensitive drum 222 to a recording sheet, a peeler 229 for releasing the recording sheet from the surface of the photosensitive drum 222, and a cleaner 226 for recovering excess toner.

Instead of the laser writing unit 227, use may be made of an optical writing head of the solid state scanning type employing a light-emitting device array comprising LEDs, ELs or the like.

Below the image forming section 210 is located the paper feed section 250 which comprises a recording sheet tray 251, a manual feed tray 254 and a reversing unit 255. Paper feed trays 252 and 253 provided in the multi-tier paper feed unit 270 are included in the paper feed section 250. The paper feed section 250 defines a sheet feed path for transporting a recording sheet fed from any one of the trays 251 to 254 to an ejected-sheet tray 219 via a transfer position between the photosensitive drum 222 and the transfer device 225 in the image forming section 210.

The reversing unit 255 communicates with a switchback path 221 for turning a recording sheet front side back for formation of an image on the reverse side of the sheet. The reversing unit 255 is replaceable with a normal sheet tray. The image forming apparatus 100 can be fitted with a large-capacity paper feed unit capable of holding several thousands of recording sheets.

On the ejection side of the image forming section 210 are provided a fixing unit 217 for fixing the toner image to each recording sheet by heating the recording sheet bearing the toner image under pressure, switchback path 221 for turning a recording sheet front side back for the formation of an image on the reverse side of the sheet, and post-processing device 260 which is provided with an up-and-down tray 261 and performs stapling or other processing for recording sheets bearing respective images formed thereon.

Each recording sheet bearing a toner image fixed at the fixing unit 217 is guided to the post-processing device 260 by a sheet ejecting roller 219 optionally through the switchback path 221, subjected to predetermined post-processing, and then ejected to the up-and-down tray 261.

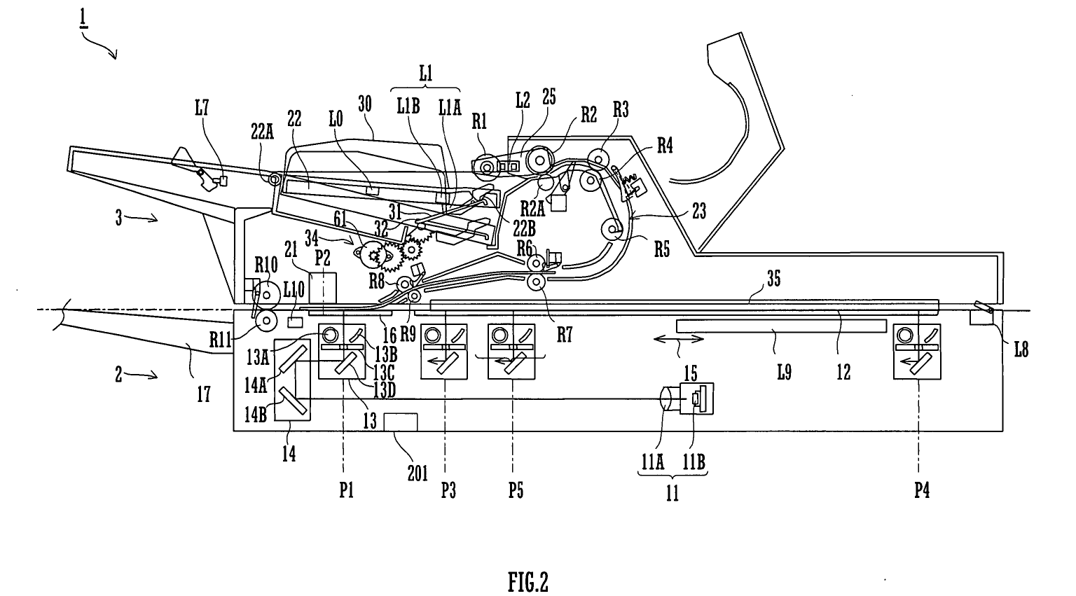

FIG. 2 is a sectional view of the image reader forming the image reading section of the digital multifunction machine according to the embodiment. The image reader 1 includes an optical system equipment section 2, and an ADF (Automatic Document Feeder) 3 as a feeder of the present invention disposed above the optical system equipment section 2. The image reader 1 serves not only as the image reading section 110 of the digital multifunction machine 100 but also as the scanner section of the copying machine or facsimile apparatus and is capable of reading images on both sides of a document.

The optical system equipment section 2 includes a CCD (Charge Coupled Device) reading unit 11 as a first reader. The optical system equipment section 2 performs image reading by using a light source unit 13 and a mirror unit 14 to form an image of the document, which is placed flat on a first platen 12 as a platen of the present invention, on the CCD reading unit 11.

The CCD reading unit 11 includes an imaging lens 11A and a CCD image sensor 11B. The light source unit 13 includes a light source 13A for emitting document-illuminating light, a reflector 13B for gathering document-illuminating light emitted from the light source 13A to a predetermined image reading position on the platen 12, a slit 13C allowing only reflected light from the document to pass therethrough, and a mirror 13D for deflecting the light path of the light having passed through the slit 13C by 90°. The mirror unit 14 includes a pair of mirrors 14A and 14B for deflecting the light path of light from the light source unit 13 by 180°. The light source unit 13 and the mirror unit 14 constitute an optical reader of the present invention.

In the stationary document read mode, the light source unit 13 and the mirror unit 14 reciprocate in the secondary scanning direction of arrow 15 between reading start position P1 and maximum reading finish position P4 at a velocity of V and a velocity of V/2, respectively, thereby guiding reflected light from the image bearing side of the document on the first platen 12 to the CCD reading unit 11 with the optical path length kept constant.

The maximum reading finish position P4 is a reading finish position used when a document of the maximum readable size is placed on the first platen 12. When a document of a smaller size than the maximum readable size is placed on the first platen 12, the reading finish position is located to oppose the right-hand edge of the document placed to abut a document position reference member 12A at its left-hand edge.

The CCD reading unit 11 may be structured to move a unit of an optical reading system for reduced-size reading or actual-size reading comprising CCD image sensor 11B, imaging lens 11A and light source 13A at a velocity V in the stationary document read mode.

The optical system equipment section 2 further includes a second platen 16 spaced a predetermined distance apart from the first platen 12 in the secondary scanning direction. In the feed-and-read mode including a traveling document read mode and a both-side read mode, the optical source unit 13 is held stationary at the reading start position P1 opposed to the lower side of the platen 16, while document sheets stacked on document tray 22 are fed to the second platen 16 one by one, whereby reflected light from the lower side (hereinafter will be defined as the obverse side) of each document sheet being fed over the second platen 16 is read. Each document sheet thus fed is ejected to an ejected sheet tray 17.

The ADF 3 includes a CIS (Contact Image Sensor) reading unit 21 as a second reader. In the both-side read mode, the ADF3 feeds the document sheets stacked on the document tray 22 to the second platen 16 one by one while reading reflected light from the lower side (hereinafter will be defined as the reverse side) of each document sheet being fed over the second platen 16 by means of the CIS reading unit 21. The ADF 3 defines a document feed path 23 on which rollers R1 to R10 and detectors L1 to L6 are arranged.

The CIS reading unit 21 includes an array of image sensors, an array of optical guide means (for example a lens array of selfoc lenses), and a light source (an LED array light source or a fluorescent lamp).

The document tray 22 is lifted up and down about a fulcrum 22A as the revolution of a lifting motor 61 is transmitted thereto via a lifting mechanism 34 and an up-and-down plate 31. When an optical document detector L1 comprising an actuator L1A and a sensor body L1B detects a stack of document sheets having been set on the document tray 22, the feed-and-read mode is selected.

When a signal to start the feeding of the document sheets is inputted, the document tray 22 is lifted until the detector R2 detects the pick-up roller R1 raised by the uppermost surface of the document sheet stack on the document tray 22 and then the pick-up roller R1 is rotated so that the document sheets are picked up one by one sequentially from the uppermost sheet of the document sheet stack. On the downstream side of the pick-up roller R1 are disposed separating rollers R2 and R2A. The pick-up roller R1 is supported by an arm 25, which is pivotally supported by the rotating shaft of the separating roller R2.

The roller R2A provided with a torque limiter (which may be a friction pad) is arranged to confront the separating roller R2 so that the document sheets are reliably fed separately one by one. Therefore, even when plural document sheets are collectively picked up by the pick-up roller R1 at a time, only the uppermost sheet is passed between the separating rollers R2 and R2A and guided toward the document feed path 23. Each document sheet thus guided to the document feed path 23 is fed to the second platen 16 by feed rollers R3 to R7 and register rollers R8 and R9 with predetermined timing.

Each document sheet having passed between register rollers R8 and R9 is guided to the reading start position P1 for scanning the obverse side of the document sheet by exposure and then passed through reading position P2 for scanning the reverse side of the document sheet by exposure. The light source unit 13 faces the lower side of the second platen 16 at the reading start position P1. The CIS reading unit 21 is exposed on the upper side of the document feed path 23 at the reading position P2.

Each document sheet having been subjected to image reading on only the obverse side thereof or on both of the obverse and reverse sides thereof is ejected by ejecting rollers R10 and R11 onto the ejected-sheet tray 17. The operation described above is repeated until the document sheets set on the document tray 22 run out, and all the document sheets finished with reading are ejected onto the ejected-sheet tray 17.

As the document sheets on the document tray 22 are fed sequentially, the height level of the uppermost one of the document sheets lowers and, hence, the pick-up roller R1 also lowers. In order to keep constant the abutting state of the pick-up roller R1 against the upper side of the uppermost document sheet, the document tray 22 is raised to compensate for a drop in the height level of the pick-up roller R1.

The position of the light source unit 13 in the secondary scanning direction is controlled by reference to its current position detected by the detector L10. During the standby state in which reading is not performed, the light source unit 13 rests at a standby position P5. The standby position P5 is established at a location where the light source unit 13 fails to face a portion adjacent the left-hand end portion of the first platen 12 but faces the lower side of the first platen 12.

The ADF 3 is pivotable about a non-illustrated hinge located between the ADF 3 and the optical system 2 on the rear side of the image reader 1 for a document to be placed on the first platen 12 for reading. This feature allows the upper side of the first platen 12 to be exposed from the front side of the image reader 1, whereby a document that cannot be fed by the ADF 3, such as a book-shaped document, can be placed on the first platen 12. On the bottom of the ADF 3 is provided an elastic document mat 35 facing the first platen 12. The open/close state of the ADF 3 is monitored by means of a non-illustrated detector included in the optical system 2.

The image reader 1 thus constructed is capable of reading a document image in each of the three modes: stationary document read mode, traveling document read mode, and both-side read mode. In the stationary document read mode, the CCD reading unit 11 reads an image of a document, such as a book-shaped document, manually placed on the first platen 12, while the light source unit 13 and the mirror unit 14 are moved to scan the document. The traveling document read mode and the both-side read mode are included in the feed-and-read mode for reading each of document sheets set on the document tray 22 while feeding them one by one automatically. In the traveling document read mode the image on the obverse side of each document sheet is read by the CCD reading unit 11 only, whereas in the both-side read mode the images on respective of the obverse and reverse sides of each document sheet are read by both of the CCD reading unit 11 and the CIS reading unit 21.

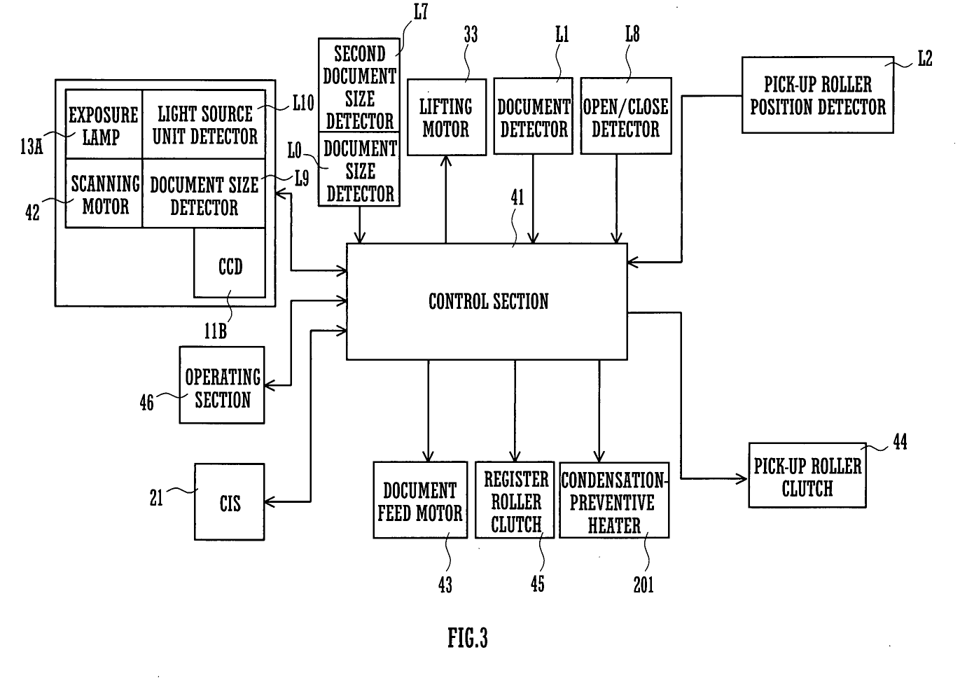

FIG. 3 is a block diagram showing the electrical configuration of the image reader 1. A control section 41 realized by a microcomputer or the like performs switching controls associated with recording sheets to be used in the image forming section 210 and with the operation timing of each section, and like controls based on the results of detections performed by document size detectors L0 and L7 adapted to detect the size of a document set on the document tray 22 and document size detector L9 disposed in the optical system 2 and adapted to detect the size of a document placed on the first platen 12.

In the stationary document read mode in which only the CCD reading unit 11 performs reading, the control section 41 drives a scanning motor 42, such as a stepping motor, to move the light source unit 13 and the mirror unit 14 while driving exposure lamp 13A and CCD 11B depending on the position of the light source unit 13 detected by light source detector L10, thereby reading the document image.

In each of the traveling document read mode and both-side read mode which use the ADF 3, the control section 41 drives the lifting motor 33 in accordance with the output of the pick-up roller position detector L2 to keep constant the height level of the uppermost one of document sheets set on the document tray 22 while controlling feed motor 43, clutch 44 of the pick-up roller R1 and clutch 45 of registration rollers R8 and R9 based on the results of detections by the detectors L3 to L6 until the document detector L1 detects the absence of any document sheet on the document tray 22. Under these conditions, the CCD 11B and CIS 21 are driven appropriately to read the image of each document sheet.

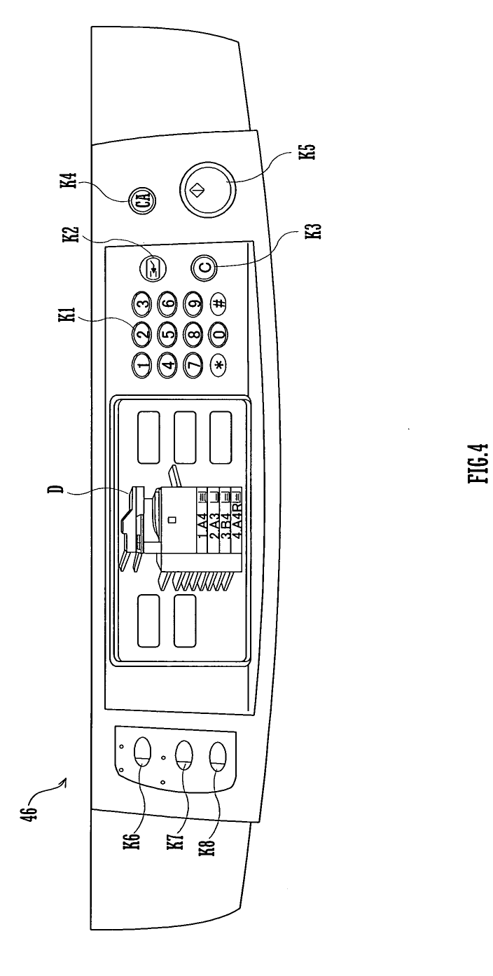

The control section 41 is connected to the operating section 46 shown in FIG. 4. The operating section 46 is provided on top of the image reader 1 and includes various types of keys K1 to K8 and an operation panel D realized by a liquid crystal touch panel or the like. On the right-hand side of the operation panel D are arranged numeric keypad K1, interrupt key K2, clear key K3, clear-all key K4 and start key K5. On the left-hand side of the operation panel D are arranged fax key K6, printer key K7 and copy key K8, which are mode keys for changing the operation mode.

The operation panel D is capable of displaying various screens by switching to one from another. Keys assigned various read conditions are displayed on these screens. By touching the display position of each key on the operation panel D, the read condition assigned to that key is established. The operation panel D also displays operation guidance, warning and the like. The control section 41 creates and outputs a screen to be displayed on the operation panel D of the operating section 46 while receiving operation signals from the keys K1 to K8 and operation panel D.

In the case where the digital multifunction machine 100 includes the image reader 1 as the image read section 110, the control section 41 may form part of the control section of the digital multifunction machine 100.

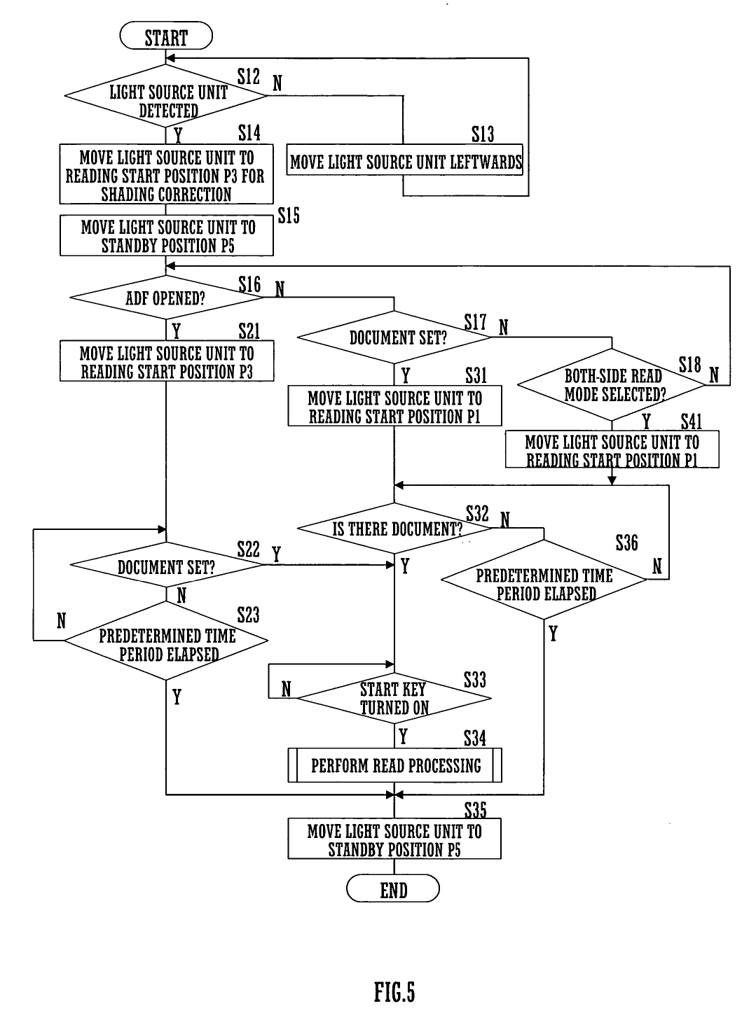

FIG. 5 is a flowchart of a processing procedure followed by the control section of the image reader. When the image reader 1 is powered on, the control section 41 starts processing and causes the light source unit 13 to move leftwards in FIG. 2 until the light source unit 13 is detected by the light source unit detector L10 (S12 and S13). Subsequently, the control section 41 causes the light source unit 13 to move a predetermined distance rightwards in FIG. 2 to the reading start position P3 using the position detected by the detector L10 as a reference, whereby reference data for shading correction is read (S14).

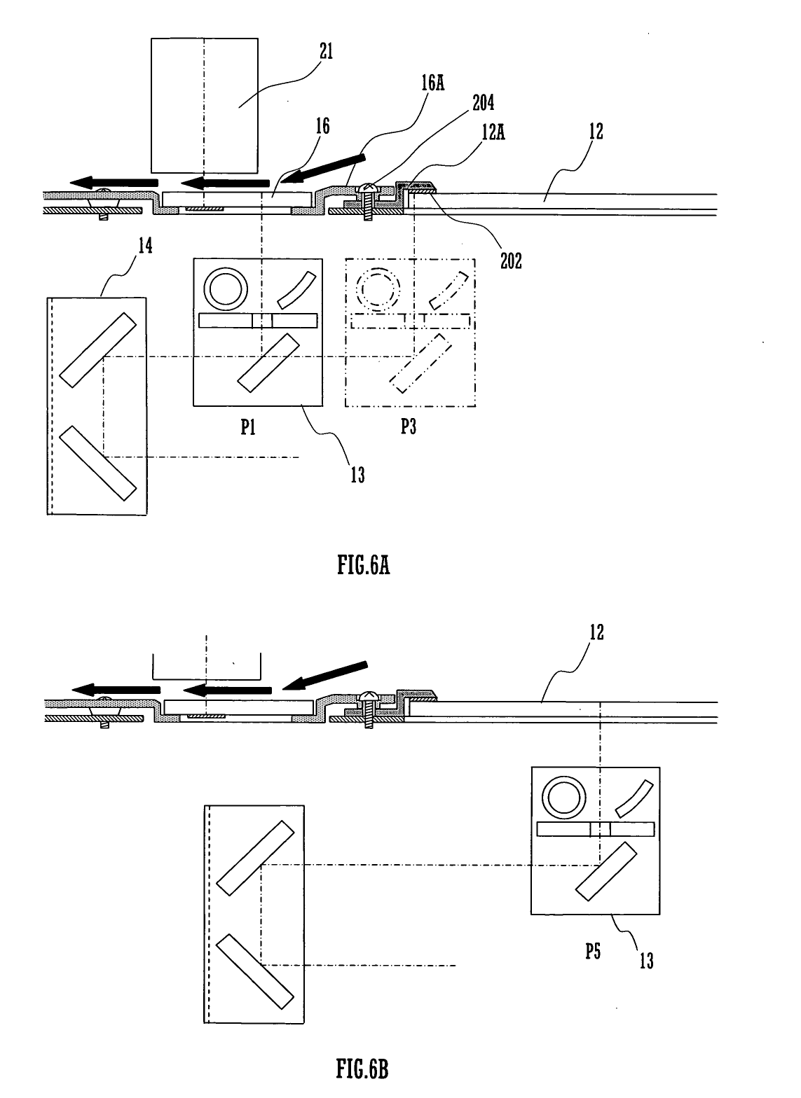

As shown in FIG. 6A, a white reference plate 202 is affixed to a left-hand end portion of the upper side of the first platen 12. At the reading start position P3 the light source unit 13 faces the white reference plate 202. The control section 41 reads the image of the white reference plate 202 as reference data on a white image to be used in shading correction for subsequent document image reading by means of the light source unit 13 stopped at the reading start position P3.

Thereafter, the control section 41 causes the light source unit 13 to move a predetermined distance rightwards in FIG. 2 to the standby position P5 (S15) and waits for the occurrence of a preparatory event such as the operation of opening/closing the ADF 3, setting of a document on the document tray 22, or the operation of selecting the both-side mode in the operating section 46 (S16 to S18). Open/close detector L8 for detecting the operation of opening/closing the ADF 3, document detector L1 for detecting the setting of a document on the document tray 22 and mode keys K6 to K8 constitute a detector of the present invention.

During waiting for such a preparatory event, when the control section 41 detects a document having been set on the document tray 22 via the document detector L1, the control section 41 judges that reading in either of the traveling document read mode and the both-side mode is to be performed and then causes the light-source unit 13 to move from the standby position P5 to the reading start position P1 (S31). At that time, the control section 41 causes the light source unit 13 to pass through the reading start position P1 and move to a position where the light source unit 13 is detected by the light source unit detector L10 and then move a predetermined distance in the opposite direction by reference to that detected position, thereby stopping the light source unit 13 at the reading start position P1 accurately.

With the light source unit 13 stopped at the reading start position P1, the control section 41 judges the condition of the document set on the document tray 22 and whether or not the start key K5 of the operating section 46 has been operated (S32 and S33). When the start key K5 is operated with the document set on the document tray 22, the control section 41 performs reading in the traveling document read mode or the both-side read mode according to a selection made at the operating section 46 (S34). Upon completion of reading of all the document sheets set on the document tray 22, the control section 41 causes the light source unit 13 to move to the standby position P5 and returns into the standby state (S35).

In the case where the document sheets on the document tray 22 run out without the start key K5 being operated, the control section 41 waits for the next setting of a document on the document tray 22 (S36) in a predetermined time period. If the predetermined time period has elapsed without the next document setting, the control section 41 performs a restoring operation to cause the light source unit 13 to return to the standby position P5 (S36?S35).

In the case where the document on the document tray 22 is removed without the start key K5 being operated, the control section 41 can judge that document reading is aborted and cause the light source unit 13 to move to the standby position P5 immediately. However, it is possible that chattering occurs at the document detector L1 during the setting of the document on the document tray 22 or that the document once set on the document tray 22 is reset for correction of the condition of the document set. For this reason the control section 41 causes the light source unit 13 to move to the standby position P5 after lapse of a predetermined time period, for example, about several tens of seconds.

When the control section 41 detects the opening of the ADF 3 by means of the open/close detector L8 during waiting for the occurrence of the preparatory event, the control section 41 judges that reading in the stationary document read mode is to be performed and then causes the light source unit 13 to move from the standby position P5 to the reading start position P3 (S16?S21). At that time, the control section 41 causes the light source unit 13 to pass through the reading start position P3 and move to a position where the light source unit 13 is detected by the light source unit detector L10 and then move a predetermined distance in the opposite direction by reference to that detected position, thereby stopping the light source unit 13 at the reading start position P13 accurately.

With the light source unit 13 stopped at the reading start position P1, the control section 41 waits for a document to be placed on the first platen 12 in a predetermined time period (S22 and S23). If the document is placed on the first platen 12 in the predetermined time period of about several ten seconds, the control section 41 waits for the start key K5 to be operated and then performs reading in the stationary document mode in response to an operation on the start key K5 (S34). Upon completion of reading of the document placed on the first platen 12, the control section 41 causes the light source unit 13 to move to the standby position P5 and returns into the standby state (S35).

Though not illustrated in FIG. 5, if a predetermined time period (about several ten seconds to about several minutes for example) has elapsed from the placement of the document on the first platen 12 without the start key K5 being operated, the control section 13 may return the light source unit 13 to the standby position P5. In this case, when the start key K5 is operated with the light source unit 13 at the standby position P5, reading is performed following the detection of the position of the light source unit 13 by the detector L10.

If the predetermined time has elapsed without any document being placed on the first platen 12, the control section 41 performs a restoring operation to cause the light source unit 13 to return to the standby position P5 (S23?S35).

When the both-side mode is selected by an operation on an appropriate mode key of the operating section 46 during waiting for the occurrence of the preparatory event, the control section 41 causes the light-source unit 13 to move from the standby position P5 to the reading start position P3 (S18?S41). At that time, the control section 41 causes the light source unit 13 to pass through the reading start position P3 and move to a position where the light source unit 13 is detected by the light source unit detector L10 and then move a predetermined distance in the opposite direction by reference to that detected position, thereby stopping the light source unit 13 at the reading start position P1 accurately.

The control section 41 waits for a document to be set on the document tray 22 in a predetermined time period (S36). If the predetermined time period has elapsed without the start key K5 being operated, the control section 13 performs a restoring operation to cause the light source unit 13 to return to the standby position P5 (S36?S35). If the document is set on the document tray 22 before lapse of the predetermined time period, the control section 41 waits for the start key K5 to be operated and then performs reading in the both-side mode in response to an operation on the start key K5 (S34). Upon completion of reading of all the document sheets set on the document tray 22, the control section 41 causes the light source unit 13 to move to the standby position P5 and returns into the standby state (S35).

In the case where the restoring operation is performed to cause the light source unit 13 to return to the standby position P5 in the step S35, the control section 41 may cause the light source unit 13 to move from the reading start position P1 or P3 to the standby position P5 directly because the standby position P5 does not necessarily require strict positional precision. Alternatively, the control section 41 may cause the light source unit 13 to move to the reference position once and then return to the standby position P5 as in the case where the light source unit 13 is caused to move from the standby position P5 to the reading start position P1 or P3.

The control by the control section 41 can be simplified by establishing a common reading start position for the reading start positions P1 and P3 in both of the stationary document read mode and the traveling document read mode. In this case, however, the light source unit 13 and the mirror unit 14 have to move a longer distance in the stationary document read mode and, hence, reading in this mode takes a longer time.

As shown in FIG. 6B, when the image forming apparatus 100 is powered off with the light source unit 13 resting at the standby position P5, the light source unit 13 is not moved. Accordingly, the light source unit 13 can be visually recognized from above through the platen 12 when the apparatus 100 is normally powered off.

If an operation for fixing the light source unit 13 and the mirror unit 14 is performed before the image forming apparatus 100 is powered off, the light source unit 13 is stopped at a position on the left-hand side of the reading start position P1 in FIG. 2. For example, after the light source unit detector L10 has detected the light source unit 13, the light source unit 13 is caused to further move a predetermined distance leftwards in FIG. 2 and stop at a position adjacent the cabinet panel of the image reader 1. Alternatively, the light source unit 13 may be caused to stop at the position where the light source unit 13 has been detected by the light source unit detector L10. Thus, the light source unit 13 can be fixed at the position where the light source unit 13 is to be detected by the light source unit detector L10. Alternatively, the light source unit 13 may be fixed at the reading start position P1.

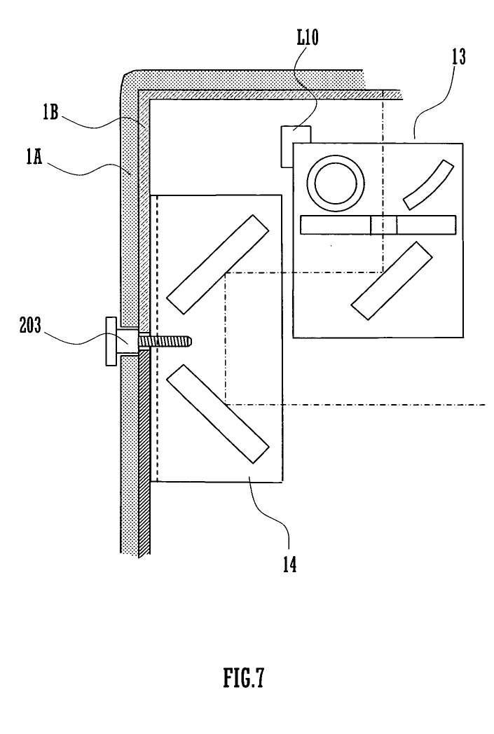

As shown in FIG. 7, the image reader 1 has an arrangement which allows at least one of the light source unit 13 and the mirror unit 14 to be fixed to cabinet panel 1A or frame 1B of the image reader 1 from the exterior of the cabinet panel 1A by means of a fixing screw 203 or the like after powering off, thereby preventing damage to the image reader 1 due to the light source unit 13 or mirror unit 14 moving during transportation or the like. Operations needed in fixing the light source unit 13 and/or the mirror unit 14 include, for example, inputting of a code from the numeric keypad of the operating section 46, and touching an optical system fixing key displayed on the operation panel D.

As shown in FIG. 2, a condensation-preventive heater 201 as a heater of the present invention is disposed on the inside bottom of the image reader 1 at a location intermediate the light source unit 13 resting at the standby position and the mirror unit 14. The condensation-preventive heater 201 is turned on to heat ambient air around the light source unit 13 and mirror unit 14 when the image reader 1 is off. Particularly where the image reader 1 is installed under a low ambient temperature condition such as in a cold district, the condensation-preventive heater 201 heats the light source unit 13 and the mirror unit 14 to a sufficiently high temperature before the inside of the image reader 1 is warmed following powering on of the image forming apparatus 100 having been off for a relatively long time, thereby preventing condensation on mirrors and the like.

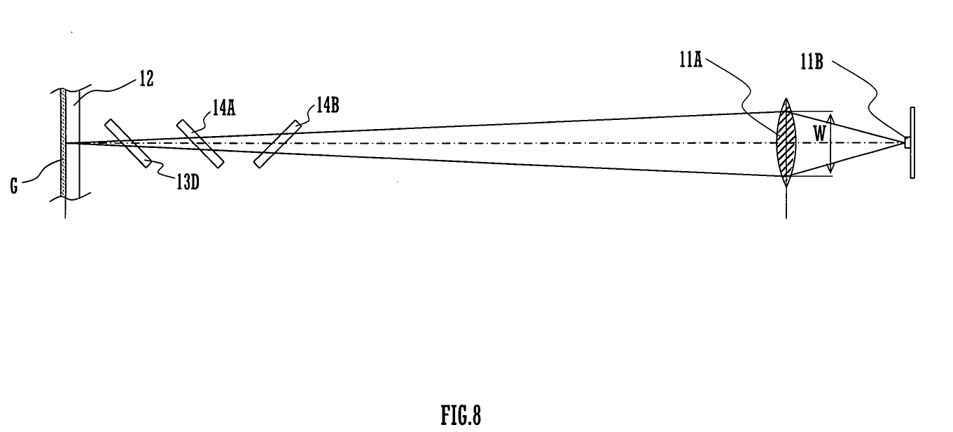

As shown in FIG. 8, reflected light from document G is deflected by mirrors 13D, 14A and 14B and then forms an image on the light-receiving portion of the CCD 11B through the imaging lens 11A. The CCD 11B reads reflected light corresponding to only one scanning line of the image of the document G and hence can read a region of the image having a mere width of about 42 μm even at a resolution of 600 dpi. That is, the light-receiving portion of the CCD 11b receives reflected light from a region of the document G having a dimension of about 42 μm in the secondary scanning direction and a dimension equal to the width of the document G in the primary scanning direction.

In the case where the light-receiving portion of the CCD 11B is capable of reading reflected light corresponding to the longitudinal dimension of a A4-size document in the primary scanning direction, a bundle of rays having a diameter of about 0.1 mm is deflected at the mirror 13D for each of about 7,000 photoelectric converters arranged in the primary scanning direction, though depending on the diameter W of the aperture of the imaging lens 11A. Accordingly, deflection of light by a mirror is impeded more seriously by very small particles of powdery paper and the like adhering thereto as the position of the mirror becomes closer to the document G. Therefore, deflection-impeded portions of reflected light do not reach the light-receiving portion of the CCD 11B, causing missing of image data. This phenomenon is most conspicuous at the mirror 13D which is closest of the three mirrors 13D, 14A and 14B to the document G. Accordingly, it is necessary to prevent powdery paper and the like from falling onto the light source unit 13 including the mirror 13D from above.

As shown in FIG. 6, the document position reference member 12A defining the position in which a document is to be placed on the first platen 12, together with support member 16A, is fixed at a location adjacent the left-hand end portion of the first platen 12 by means of fixing screw 204. Powdery paper, dust and the like are likely to collect in clearances between the first platen 12 and the document position reference member 12A and between the document position reference member 12A and the support member 16A.

While the standby position P5 is established at a location spaced about 70 mm apart from the reading start position P1 in the image reader 1 according to the present embodiment, the standby position P5 may be established at any location at which dust, waste, powdery paper or cuttings fail to fall onto the light source unit 13 from above, without limitation. Therefore, it is possible to establish the standby position P5 at a location on the opposite side of the first platen 12 away from the reading start position P1. However, this arrangement can increase the size of the image reader 1 and hence is not preferable.

In the present embodiment the standby position P5 of the light source unit 13 is established at a location where the light source unit 13 faces the lower side of the first platen 12, so that the light source unit 13 can be visually recognized through the first platen 12 from above when power to the image reader 1 is off. This arrangement can avoid cuttings, which are produced on such an occasion when the screw fixing the document position reference member 12A and the like is screwed out for maintenance of the first platen 12, second platen 16, light source unit 13 and the like, from falling onto the light-source unit 13 and prevent powdery paper and dust collecting in clearances from falling onto the light source unit 13 due to propagation of vibration during the operation of the digital multifunction machine 100 or on the occasion of removal of the first platen 12 or the second platen 16.

Further, as compared with the case where the light source unit 13 is positioned under the frame supporting the first platen 12 or the second platen 16, the arrangement of the present embodiment in which the light source unit 13 is positioned so as to be visually recognized from outside can eliminate the operation of drawing out the light source unit 13 by hand after the removal of the first platen during maintenance and hence can prevent the operator from inadvertently soiling or damaging the light source 13A, reflector 13B or mirror 13D included in the light source unit 13 by touching with the same by his or her hand or finger.

The foregoing embodiment is illustrative in all points and should not be construed to limit the present invention. The scope of the present invention is defined not by the foregoing embodiment but by the following claims. Further, the scope of the present invention is intended to include all modifications within the meanings and scopes of claims and equivalents.

1. An image reader comprising: a platen for a document to be placed thereon; and the optical reader capable of moving relative to an image bearing side of the document along the platen intervening therebetween, wherein a standby position at which the optical reader rests during standby for image read processing is established at a location where the optical reader fails to face an end portion of the platen which lies in a direction in which the optical reader is movable relative to the image bearing side of the document.

2. The image reader according to claim 1, wherein the standby position is a position at which the optical reader faces a lower side of the platen.

3. The image reader according to claim 1, further comprising a detector operative to detect an occurrence of a preparatory event for reading an image of the document, wherein when the detector detects the occurrence of the preparatory event, the optical reader is moved from the standby position to a reading start position which allows the optical reader to start reading the image of the document.

4. The image reader according to claim 3, which performs a restoring operation to move the optical reader from the reading start position to the standby position if reading of the image of the document is judged to be unready to start after the optical reader has been moved to the reading start position following the detection of the occurrence of the preparatory event by the detector.

5. The image reader according to claim 4, wherein the restoring operation is performed when a predetermined time period has elapsed from the detection of the occurrence of the preparatory event by the detector without the reading of the image of the document being started.

6. The image reader according to claim 1, further comprising a heater located adjacent the standby position of the optical reader for heating the optical reader.

7. The image reader according to claim 1, further comprising a feeder operative to feed the document onto the platen.

8. The image reader according to claim 1, which is operable selectively in one of a feed-and-read mode for reading the image of the document being fed over the platen by the optical reader stopped at a first reading start position at which the optical reader faces the platen and a stationary document read mode for reading the image of the document placed on the platen by the optical reader moving from a second reading start position at which the optical reader faces one end of the document placed on the platen to a reading finish position at which the optical reader faces an opposite end of the document.

9. An image forming apparatus comprising an image reader including: a platen for a document to be placed thereon; and an optical reader capable of moving relative to an image bearing side of the document along the platen intervening therebetween, wherein a standby position at which the optical reader rests during standby for image read processing is established at a location where the optical reader fails to face an end portion of the platen which lies in a direction in which the optical reader is movable relative to the image bearing side of the document, wherein
image forming processing is performed based on the image of the document read by the image reader.
